(19) United States
(12) Patent Application Publication
(10) Pub. No.: US 2011/0116898 A1
(43) Pub. Date: May 19, 2011

(54) FASTENER FOR LENSES

(76) Inventor: Cristiano Malavasi, Trissino (IT)

(21) Appl. No.: 12/736,739

(22) PCT Filed: May 8, 2009
(86) PCT No.: PCT/EP2009/003289

§ 371 Date: Jan. 31, 2011

(30) Foreign Application Priority Data
May 9, 2008 (IT) VI2008A000105
Jun. 4, 2008 (IT) VI2008A000132
Dec. 5, 2008 (IT) VI2008U00048

(51) Int. Cl. F16B 19/00

(52) U.S. Cl. 411/508

(57) ABSTRACT

A fastener, particularly for lenses, has an elastically deformable elongated body that is suitable to be inserted in through holes formed in one of the members to be joined; the elongated body comprises a substantially cylindrical stem that has a first end that forms a wider head and a second end that forms a plurality of frustum-shaped members that are arranged in series; the bases of the frustum-shaped members are directed towards the wider head the second end terminates into an extension, the diameter of the wide head and the diameter of the bases are greater than the diameter of the stem.

The present invention relates to a fastener for lenses, which is suitable both to fix lenses to frames and to mate lenses of different types.

As is known, traditionally the lenses are fastened to the frames of eyeglasses by means of small screws or bolts.

The screws are generally inserted in through holes that are formed in the lenses and are made to engage corresponding female threads formed in the frames.

The bolts are fastened by means of nuts.

A first inconvenience of the traditional fasteners regards the slowness of the assembly operations. The small size of the screws and the fragility of the lenses in fact require a great certain care during assembly.

Also, the screws require the use of deformable washers or of other tension-preventing spacers which must be interposed between the metallic components and the lenses in order to protect the lenses themselves.

Another drawback of the conventional screws is that, over time, they might loosen due to vibrations or less than perfect assembling.

Yet another drawback is that the holes provided in the frames must be threaded and such threading operation is onerous, both in terms of time and in terms of costs.

Another drawback of the conventional fasteners relates to the aspect of safety, because the screws or nuts very often protrude from the internal surface of the frame and may injure the wearer in case of accidents.

Conventional screws are also inconvenient when used in so-called “rimless” frames, such as “glasant” and “nylor” frames.

Those frames are characterized by minimal and particularly lightweight structures, which do not alter radically the features of the wearer because they are almost invisible.

In particular, glasant frames are constituted by a bridge, provided with nose pads, and by two temples with corresponding hinges.

Currently, the lenses are fastened to such structures by means of screws or pins inserted in holes or seats formed directly in the lenses.

In other glasses, a nylon wire is braided and tied in order to provide complicated knots joining the lens to the frame.

The assembly of rimless frames with current assembly technologies appears in fact to be excessively laborious, requiring considerable effort and particular attention. Accordingly, the assembly is time consuming and expensive from a production point of view.

The aim of the invention is to overcome the inconveniences of the prior art fasteners by providing a fastener that is durable and safe and at the same time allows an easy and quick assembly of the lens to the frame.

Within the scope of this aim, a particular object of the invention is to provide a fastener that can be installed with a simple operation and does not require the use of tools or particular fittings.

A further object of the invention is to provide a fastener that requires no threading.

A further object of the invention is to provide a fastener that allows mating different types of lenses while remaining concealed from sight.

A further object of the invention is to provide a fastener that ensures the safety of the wearer even in case of accidents.

A further object of the invention is to provide a fastener that is advantageous from a purely economic standpoint.

A further object of the invention is to provide a fastener that minimizes the probability of lens breakage.

A further object of the invention is to provide a fastener that could be replaced easily in case of breakage.

A further object of the invention is to provide a fastener that is at the same time safe and almost invisible after assembly.

This aim, these objects and others that will become better apparent hereinafter are achieved by a fastener, particularly for lenses, characterized in that it comprises an elastically deformable elongated body that is suitable to be inserted in through holes formed in one of the members to be joined, said elongated body comprising a substantially cylindrical stem that has a first end that forms a wider head and a second end that forms a plurality of frustum-shaped members that are arranged in series; the bases of said frustum-shaped members are directed towards said wider head; said second end terminates into an extension; the diameter of said wider head and the diameter of said bases being greater than the diameter of said stem.

Further characteristics and advantages will become better apparent from the description of preferred but not exclusive embodiments of an fastener according to the invention, illustrated by way of non-limiting example in the accompanying drawings, wherein

FIG. 1 is a perspective view of a fastener according to the invention;

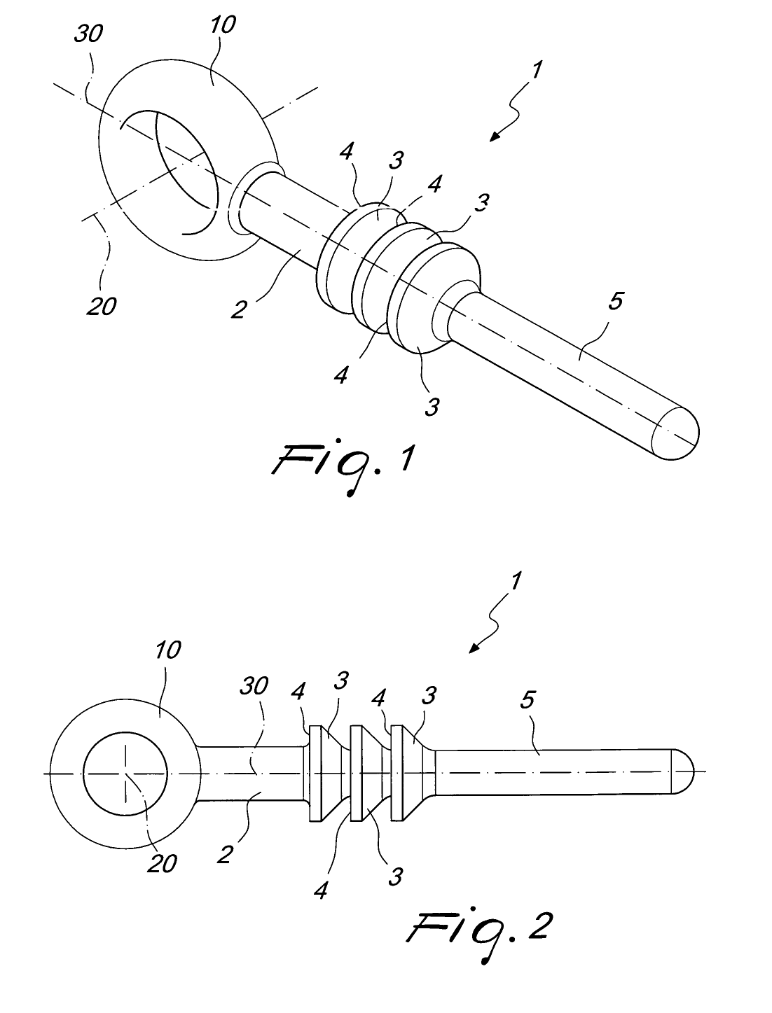

FIG. 2 is a side view of the fastener of the preceding figure;

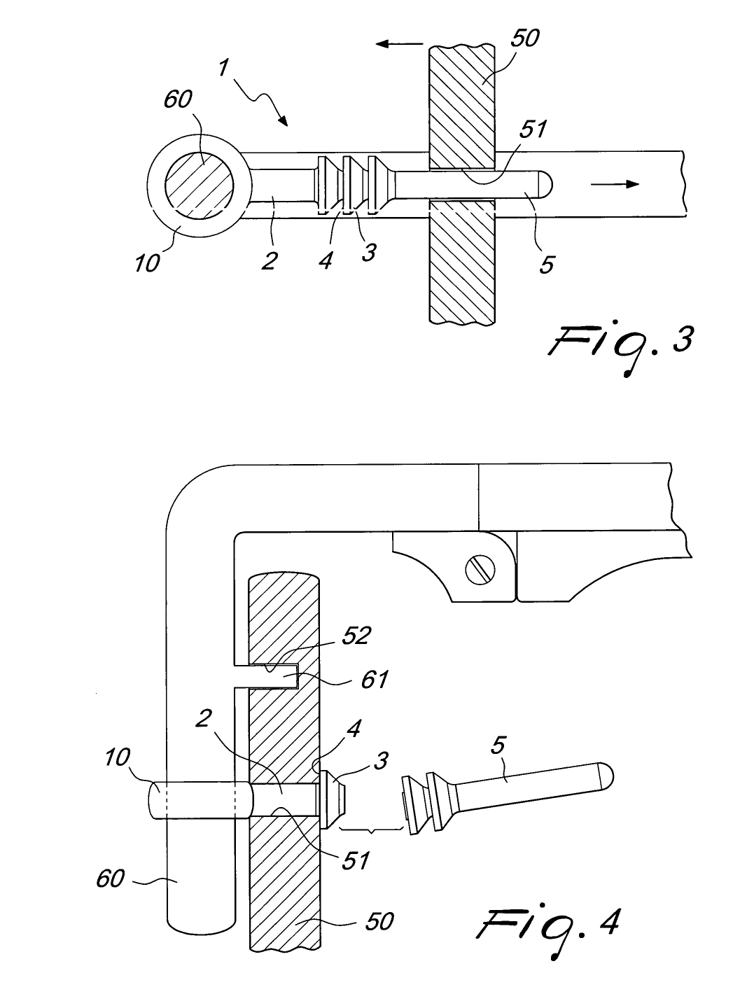

FIG. 3 is a partially sectional side view of an example of application of the fastener according to the invention;

FIG. 4 is a partially sectional plan view of the example of application of the preceding figure;

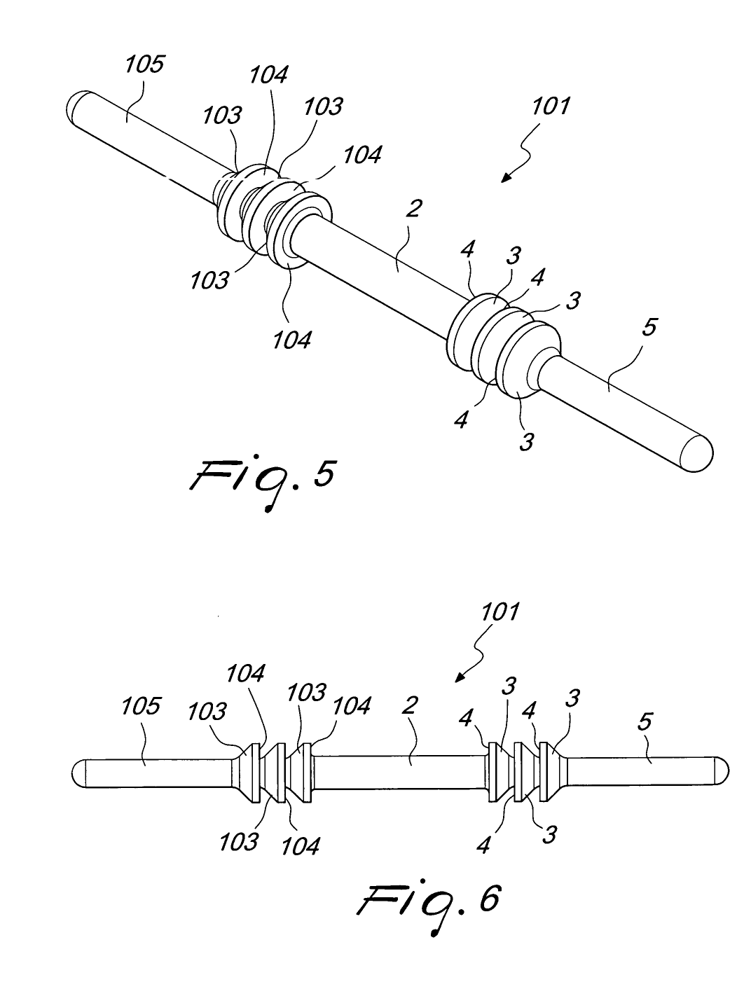

FIG. 5 is a perspective view of a further embodiment of the fastener according to the invention;

FIG. 6 is a side view of the fastener of the preceding figure;

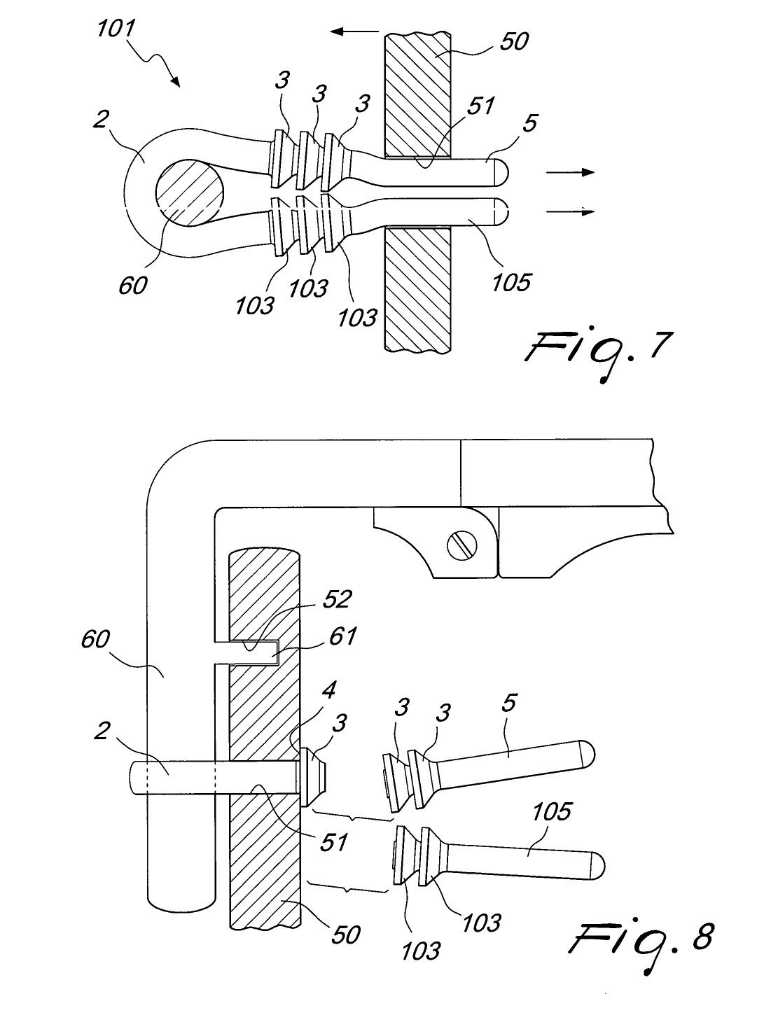

FIG. 7 is a partially sectional side view of an example of application of the fastener shown in FIGS. 5 and 6;

FIG. 8 is a partially sectional plan view of the example of application of the preceding figure;

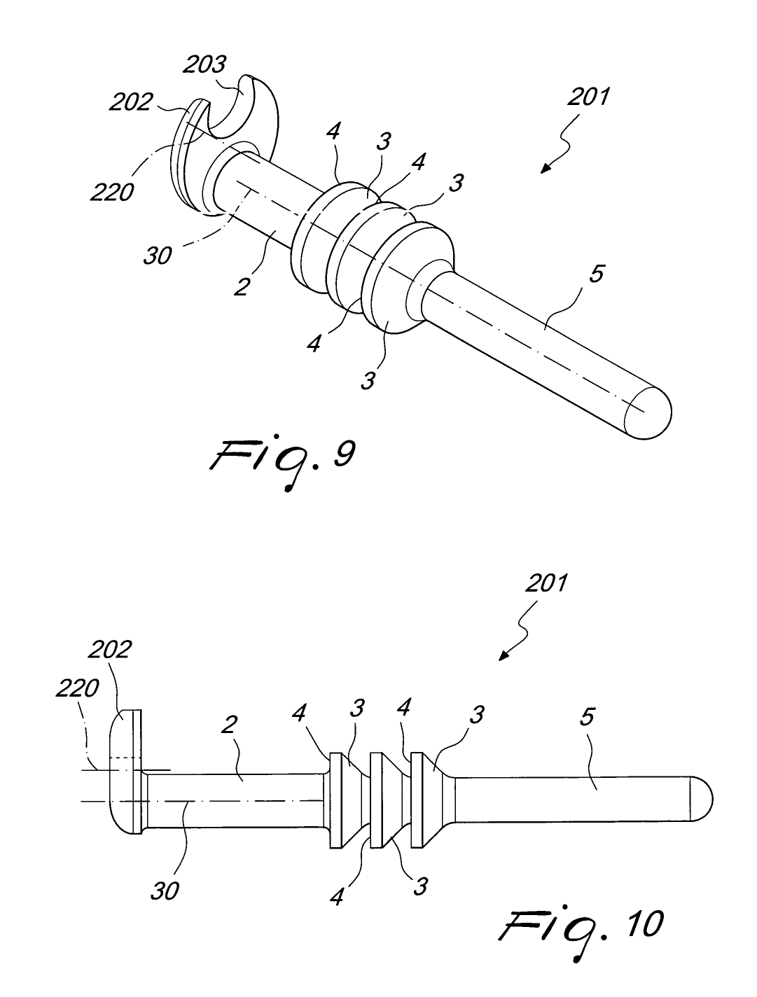

FIG. 9 is a perspective view of a further embodiment of the fastener, according to the invention;

FIG. 10 is a side view of the fastener of the preceding figure;

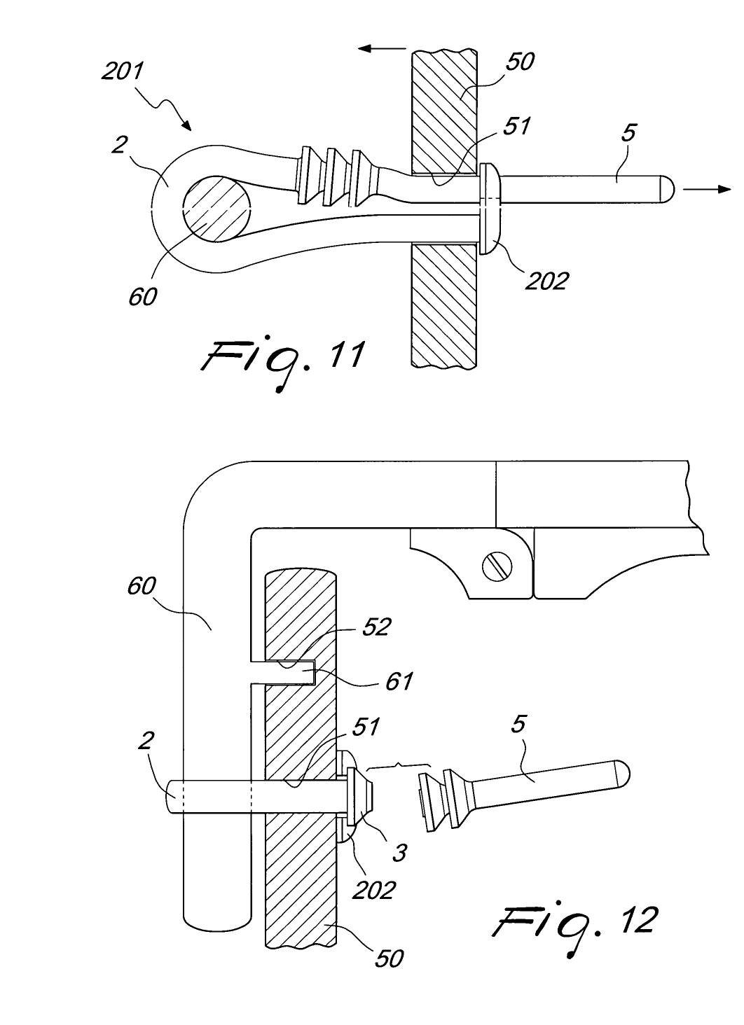

FIG. 11 is a partially sectional side view of an example of application of the fastener shown in FIGS. 9 and 10;

FIG. 12 is a partially sectional plan view of the example of application of the preceding figure;

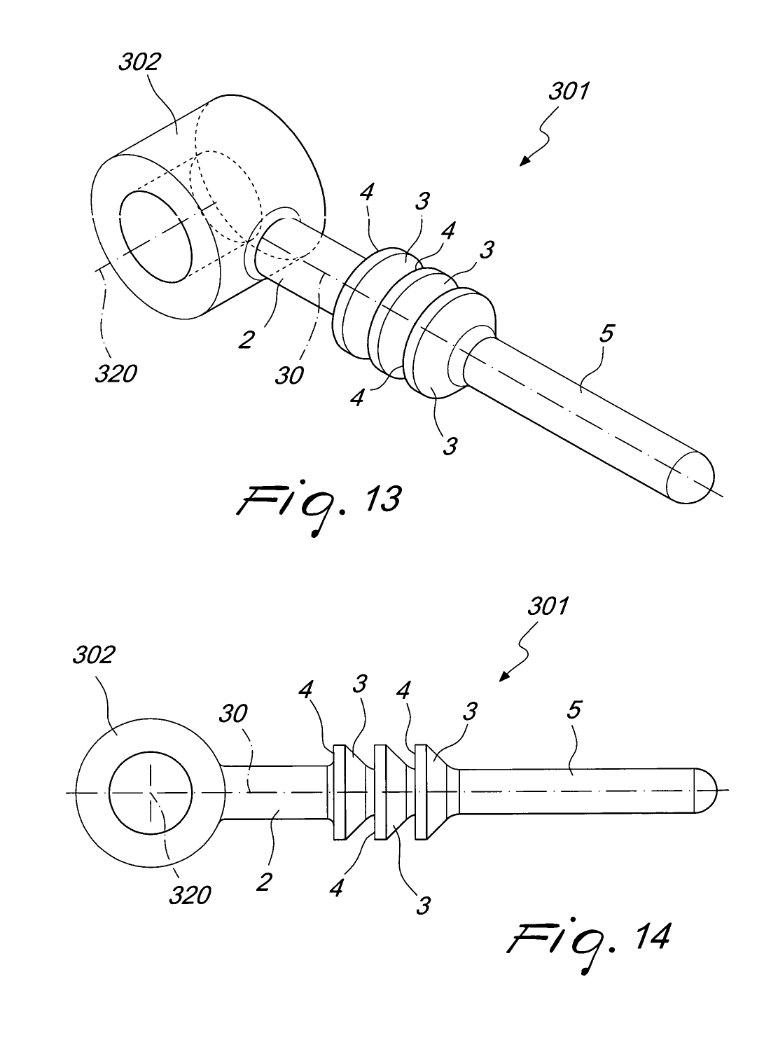

FIG. 13 is a perspective view of a further embodiment of the fastener according to the invention;

FIG. 14 is a side view of the fastener of the preceding figure;

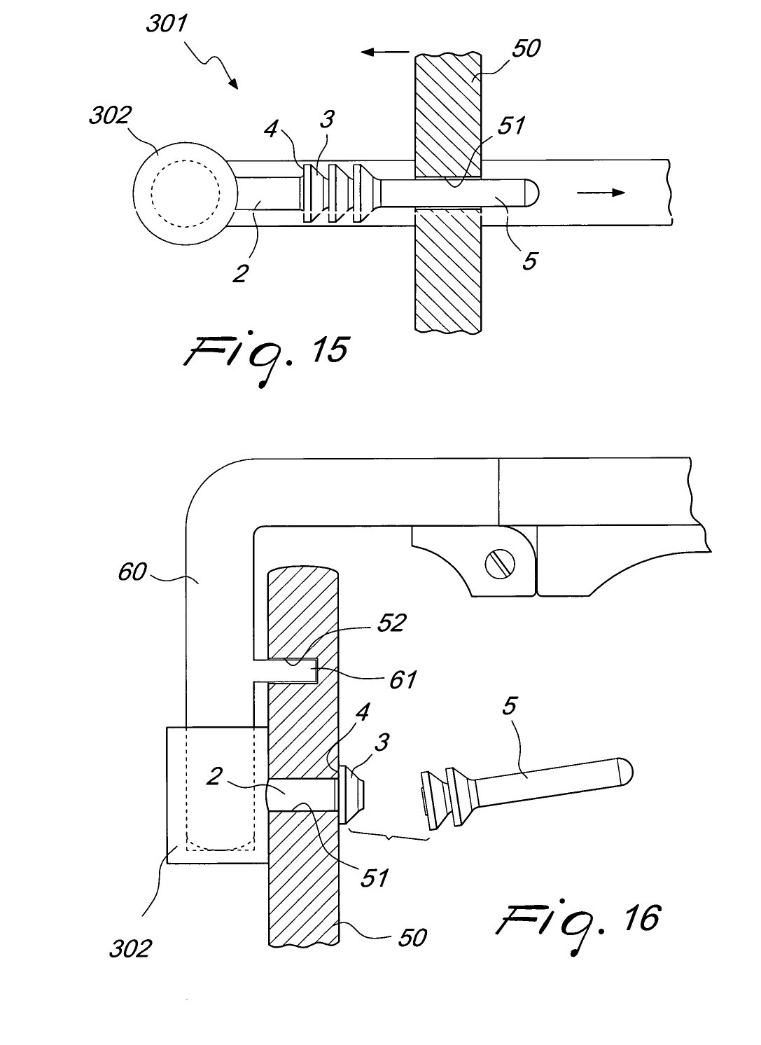

FIG. 15 is a partially sectional side view of an example of application of the fastener shown in FIGS. 13 and 14;

FIG. 16 is a partially sectional plan view of the example of application of the preceding figure;

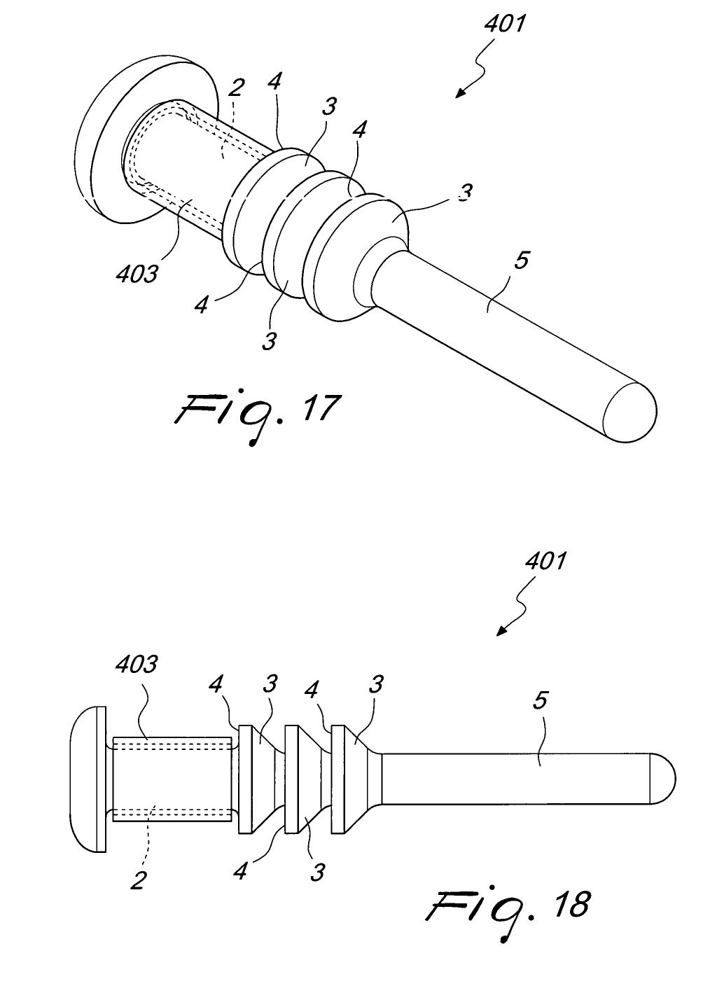

FIG. 17 is a perspective view of a further embodiment of the fastener according to the invention;

FIG. 18 is a side view of the fastener of the preceding figure;

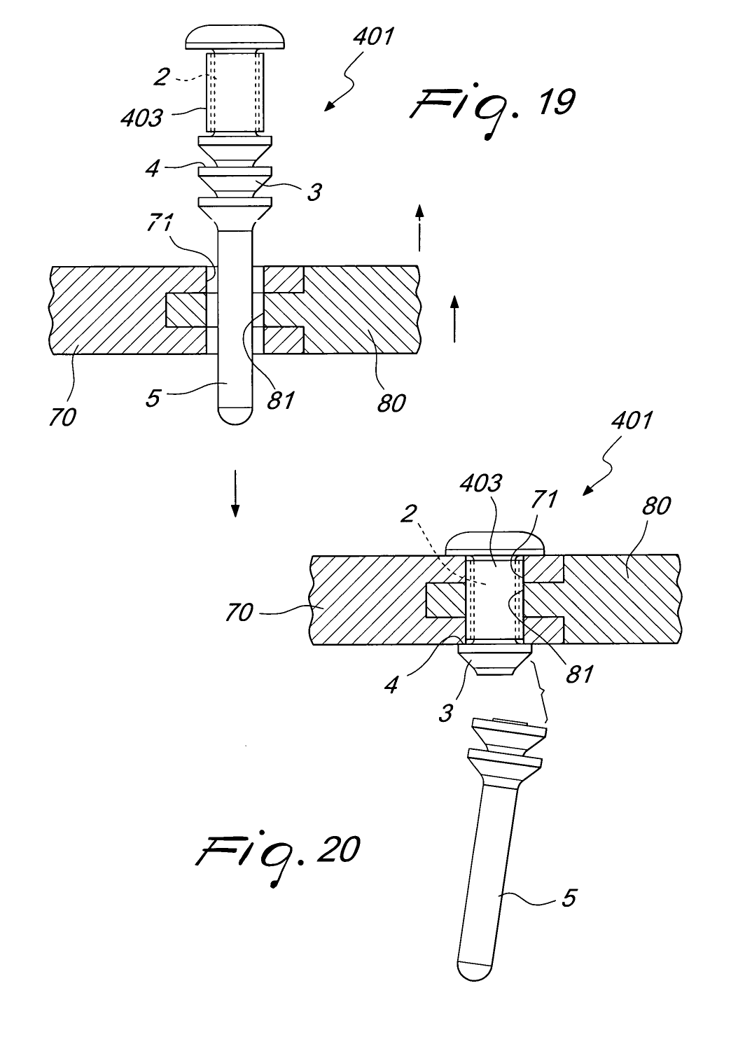

FIG. 19 is a partially sectional side view of an example of application of the fastener shown in FIGS. 17 and 18;

FIG. 20 is another partially sectional side view of the example of application of the fastener shown in FIGS. 17 and 18;

FIG. 21 is a perspective view of a further embodiment of the fastener according to the invention;

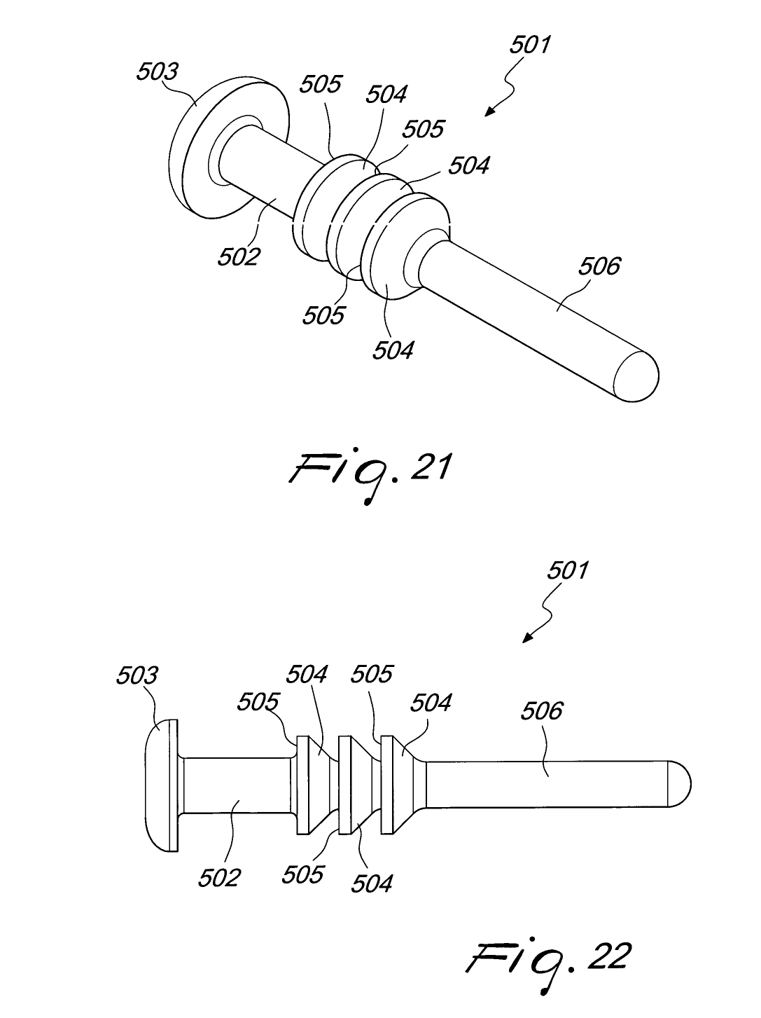

FIG. 22 is a side view of the fastener of the preceding figure;

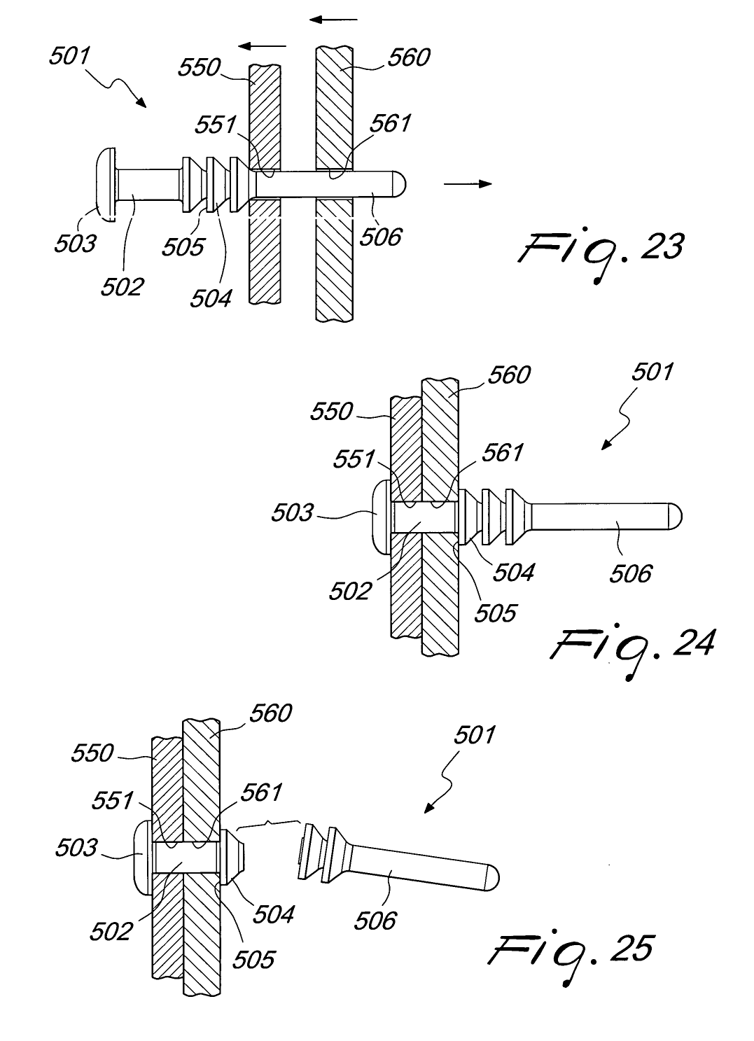

FIG. 23 is a side view of the fastener according to the invention in an example of application;

FIG. 24 is another side view of the fastener of the preceding figure;

FIG. 25 is another side view of the fastener of the preceding figure;

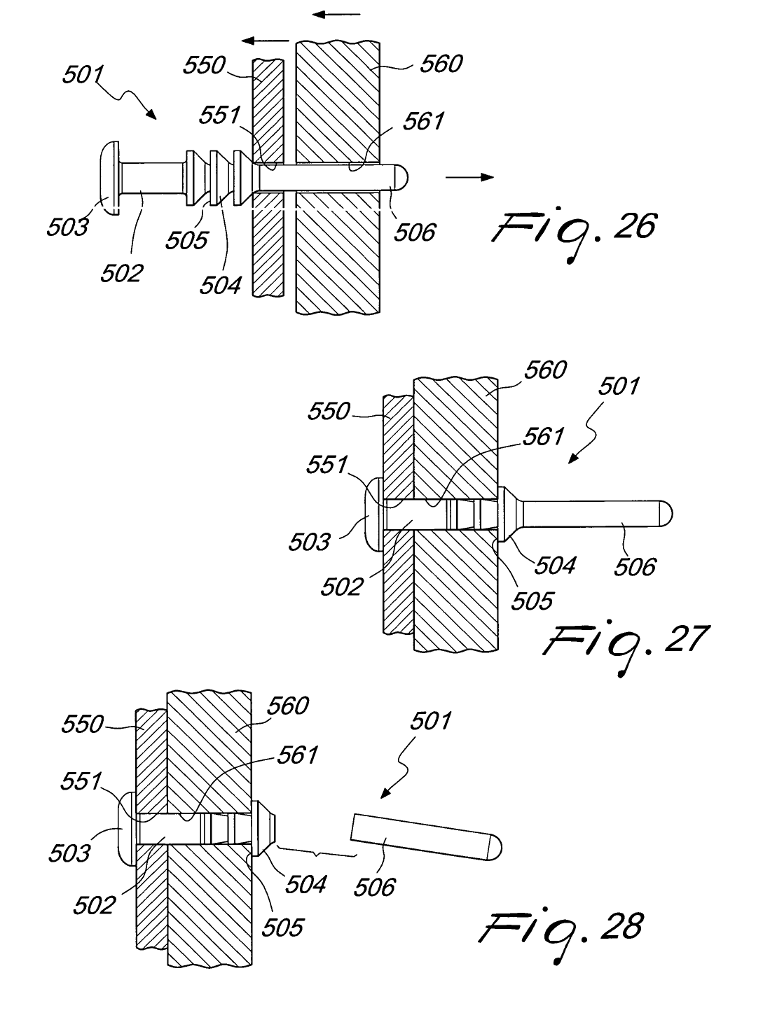

FIG. 26 is a side view of the fastener according to the invention in a further example of application;

FIG. 27 is another side view of the fastener of the preceding figure;

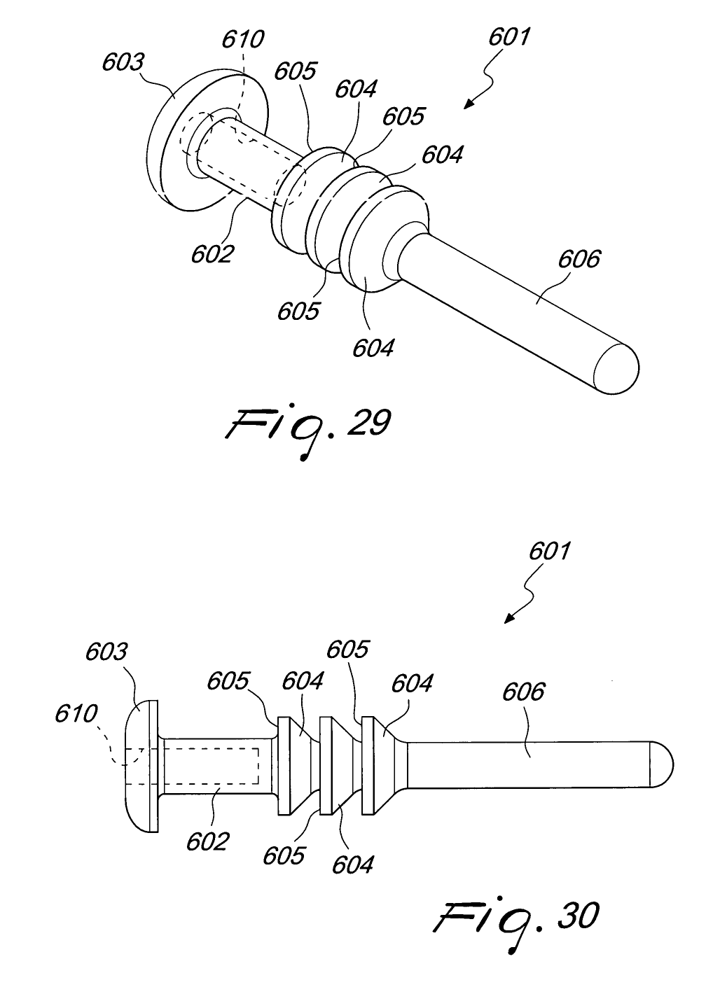

FIG. 28 is another side view of the fastener of the preceding figure;

FIG. 29 is a perspective view of a fastener according to the invention;

FIG. 30 is a side view of a further embodiment of the fastener according to the invention;

FIG. 31 is a side view of the fastener of the preceding figure in an example of application;

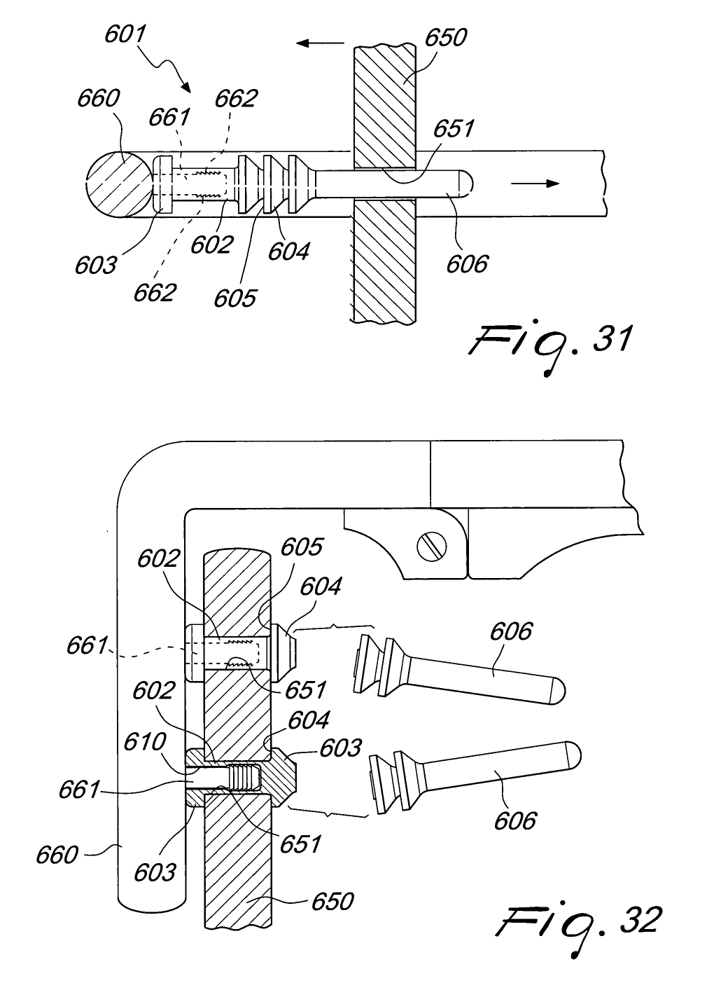

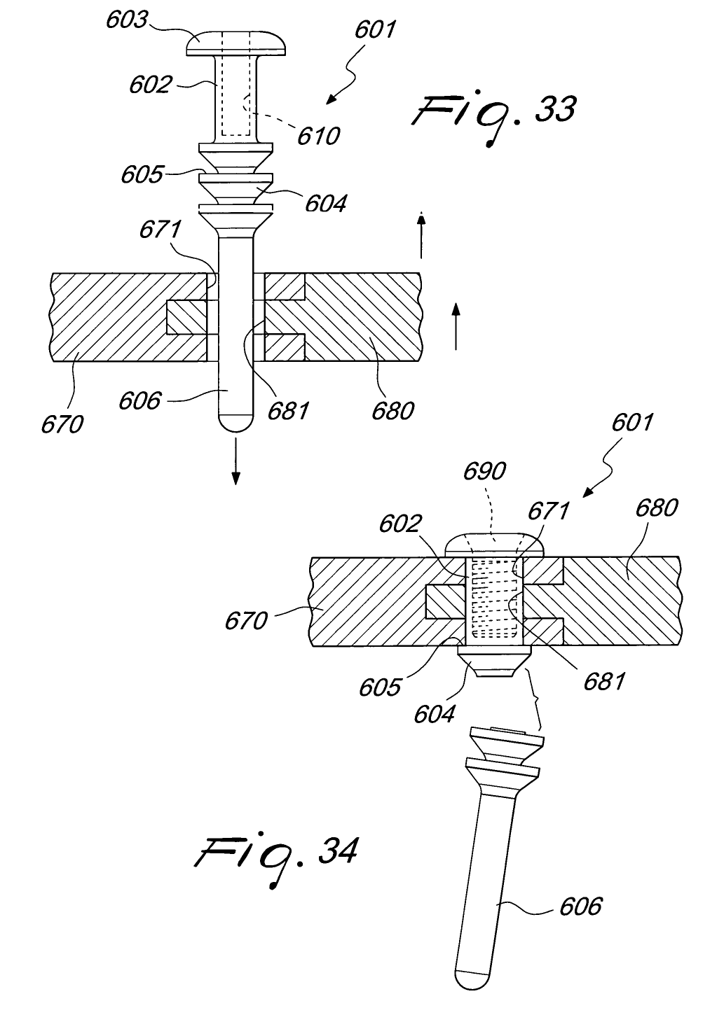

FIG. 32 is a plan view of the fastener of the preceding figure;

FIG. 33 is a side view of the fastener according to the invention in a further example of application;

FIG. 34 is another side view of the fastener of the preceding figure;

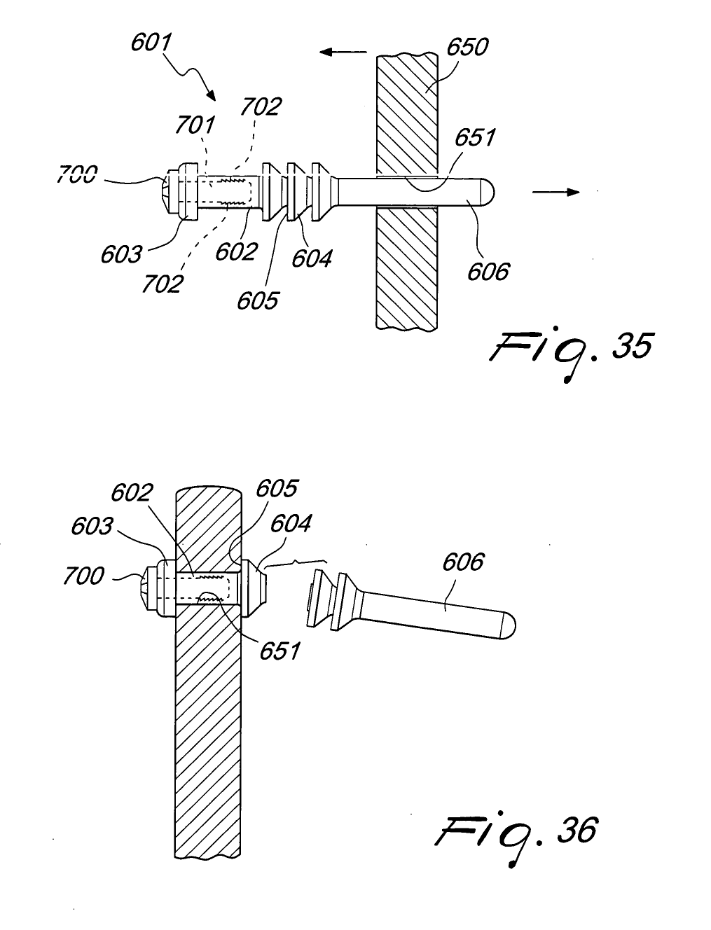

FIG. 35 is a side view of the fastener according to the invention in a further example of application;

FIG. 36 is another side view of the fastener of the preceding figure.

With reference to the cited FIGS. 1 to 4, a fastener, particularly for lenses, is globally designated by the reference numeral 1.

The fastener 1 comprises an elastically deformable elongated body, which is obtained monolithically by injection moulding. In particular, the fastener is made of polyurethane resins that can be coloured and are substantially transparent and make it difficult to perceive after application.

The elongated body has a cross-sectional profile which is substantially circular or polygonal, and is designed to be inserted in a through hole 51 that is formed in a first member 50 to be joined to a second member 60.

In the specific case, the first member 50 is constituted generally by a corrective or filtering lens, while the second member 60 is a frame portion.

The elongated body includes a substantially cylindrical stem 2, which has a first end at which a first plurality of frustum-shaped members 3 that end with a first extension 5 are provided.

The frustum-shaped members 3 are substantially mutually identical and are arranged in series, with their bases 4 oriented in the same direction. The bases have a larger diameter than the stem 2, which is instead smaller than, or equal to, the diameter of the through hole 51.

The compressibility of the frustum-shaped members 3, combined with the extendibility of the stem 2, which tend to resume their original shape and dimensions when stresses cease, allow to insert the fastener 1 within the through hole 51 and to lock the first member 50 by applying thereto a slight compression.

The fastener 1 comprises a head formed at a second end of the stem 2 that lies opposite the end from which the frustum-shaped members 3 protrude.

The distance between the head and at least one of the bases 4 is slightly shorter than the thickness of the first member 50.

The head comprises an elastically deformable ring 10, which has a round or oval shape.

The ring 10 is integral with the stem 2 and its central axis 20 is transverse with respect to the longitudinal axis 30 of the stem 2.

In the embodiment shown in FIGS. 5 to 8, wherein the fastener has been globally designated by the reference numeral 101, the head is constituted by a second plurality of frustum-shaped members 103 that lie opposite the frustum-shaped members 3 and end with a second extension 105.

The frustum-shaped members 103 are substantially mutually identical and are arranged in series with the bases 104 oriented in the same direction. The bases have a diameter that is larger than the diameter of the stem 2.

As an alternative, the frustum-shaped members 103 might be orientated with the same orientation as the frustum-shaped members 3.

In another embodiment of the fastener according to the invention, shown in FIGS. 9 to 12, and globally designated by the reference numeral 201, the head is constituted by a disk member 202, which is connected to the stem 2 so that its central axis 220 is parallel to, but does not coincide with, the longitudinal axis 30 of the stem 2.

A contoured portion 203 is provided on the disk member 202 and has a profile that is substantially complementary with respect to the profile of the transverse cross-section of the stem 2.

According to a further embodiment, shown in FIGS. 13 to 16, the fastener 301 has a head constituted by a cap 302 which is elastically deformable and has a substantially cylindrical shape.

The hood 302 is integral with the stem 2 and its longitudinal axis 320 is transverse with respect to the longitudinal axis 30 of the stem 2.

According to a further embodiment, shown in FIGS. 17 to 20, the fastener 401 has a stem 2 that is at least partially covered by a substantially rigid jacket 403, which is preferably constituted by a metal bush.

This prerogative allows inserting the fastener 401 between the members 70 and 80 of a hinge, using it as a pivot.

In the embodiments shown in FIGS. 5 to 20, the parts that corresponds to the parts that have already been described, with reference to the embodiment shown in FIGS. 1 to 4, have been designated by the same reference numerals.

The operation of the fastener according to the invention is as follows.

After providing the through hole 51 and at least one notch 52 on the first member 50, i.e. on the lens, the second member 60, which corresponds to the end portion of a temple or bridge, is inserted in the ring 10, which adapts elastically.

The first extension 5 is then inserted in the through hole 51, and then traction is applied to the fastener 1.

The stress forces the frustum-shaped members 3 to enter the through hole 51, compressing elastically, and induces them to pass through the entire thickness of the first member 50, making them emerge from the opposite side.

When the pivot 61 is interlocked perfectly in the notch 52, and the second member 60 abuts against the first member 50, causing a slight elastic elongation of the stem 2, the traction ceases.

The stem 2 therefore tends to at least partially resume its original dimensions and causes the base 4 of one of the frustum-shaped members 3 to abut against the first member 50.

The two members to be connected are consequently locked by the ring 10 and by the frustum-shaped member 3 that it is located, with respect to the first one, at a distance that is slightly shorter than the thickness of the first member 50.

However, the elasticity of the stem 2 allows, in case of accidental stresses, to protect the integrity of the first member 50 and of the second member 60.

The frustum-shaped member 3 that abuts against the first member 50 might be the one closest to the ring 10 or one that is closer to the extension 5.

The excess portion of the fastener 1, constituted only by the extension 5 or also by some frustum-shaped members 3, is finally removed.

The frustum-shaped members 3 have the prerogative of being safe against injury, and therefore even if one of them protrudes from the first member 50 this does not compromise the safety of the wearer, even in case of accidental impact.

If the ring 10 is replaced by the cap 302, the use of the fastener 301 substantially corresponds to what has already been described.

Vice versa, if the head is the one of the second series of frustum-shaped members 103, the fastener 101 is substantially bent into a U-shaped arrangement, so as to form a slot that accommodates the second member 60.

The first extension 5 and the second extension 105 are then inserted in the through hole 51, and then traction is applied to the fastener 101.

The stress forces the frustum-shaped members 3 and 103 to enter the through hole 51, compressing elastically, and induces them to pass through the entire thickness of the first member 50, making them emerge from the opposite side.

The subsequent operations substantially correspond to the ones that have already been described.

If the head is constituted by the disk member 202, the first extension 5 is inserted in the through hole 51, so that the disk member 202 abuts against a face of the first member 50.

The stem 2 is substantially bent into a U-shaped arrangement, so as to form a slot that accommodates the second member 60 on the face of the first member 50 that lies opposite the one on which the disk member 202 rests, and then the first extension 5 is reinserted in the through hole 51 and in the contoured portion 203.

Traction is then applied to the fastener 201, forcing the frustum-shaped members 3 to enter the through hole 51, compressing elastically, and inducing them to pass through the entire thickness of the first member 50, making them emerge from the face on which the disk member 202 rests.

The subsequent operations substantially correspond to the ones already described.

In a different possible application, shown in FIGS. 19 and 20, the fastener 401 is used as a pivot in a hinge.

The first extension 5 is inserted in the through holes 71 and 81, formed respectively in the members 70 and 80 of the hinge, and then traction is applied to the fastener 401.

The stress forces the frustum-shaped members 3 to enter the through holes 71 and 81, compressing elastically, and induces them to pass through the entire thickness of the hinge.

When the jacket 403 is inserted perfectly in the through holes 71 and 81 and the head of the fastener 401 abuts against a first side of the member 70, traction ceases.

The stem 2 then tends to retract elastically, and moves the base 4 of one of the frustum-shaped members 3 into abutment against the second side of the member 70.

The excess portion of the fastener 1 is finally removed.

With reference to FIGS. 21 to 28, a fastener particularly for lenses is generally designated by the reference numeral 501.

According to the invention, the fastener 501 comprises an elastically deformable elongated body, which is provided monolithically, preferably by injection moulding of suitable polyurethane resins.

The elongated body is designed to be inserted within a first through hole 551 and a second through hole 561, which are not threaded and are provided respectively in a first member 550 and in a second member 560 to be joined. These members can be constituted for example by corrective lenses, filtering lenses, or frame portions.

The elongated body includes a stem 502, which is substantially cylindrical and has a first end that is blended with a wider head 503 and a second end at which there is a plurality of frustum-shaped members 504 which end with an extension 506.

The frustum-shaped members 504 are elastically compressible and therefore have the prerogative of being safe against injury. They are substantially mutually identical and are arranged in series with the larger end faces 505 directed toward the wider head 503.

The distance between the wider head 503 and at least one of the bases 505 substantially corresponds to the thickness that is the result of the juxtaposition of the first member 550 and the second member 560.

The diameter of the wider head 503 and the diameter of the bases 505 are both greater than the diameter of the stem 502, which corresponds substantially to the diameter of the two through holes 551 and 561.

These features, together with the extendibility of the stem 502 and the compressibility of the frustum-shaped members 504, which when the stresses cease tend to resume their original shape, allow to insert the fastener 501 within the through holes 551 and 561 and to lock the first member 550 and the second member 560 between the wider head 503 and at least one of the frustum-shaped members 504.

The polyurethane resins can be coloured and are substantially transparent. This allows to make the fastener 501 concealed from sight after application.

The expanded head 503 is shaped so as to allow providing logos or particular indications on its exposed face.

The operation of the device according to the invention is as follows.

The first member 550 is juxtaposed on the second member 560, so that the first through hole 51 is substantially coaxial to the second through hole 561.

The extension 506 is then inserted within the through holes 551 and 561 and then traction is applied to the fastener 501.

The stress forces the frustum-shaped members 504 to enter the through holes 551 and 561, compressing elastically, and induces pass through the entire thickness of the first member 550 and of the second member 560, making them emerge from the latter.

When the wider head 503 abuts against the first member 550, causing a slight elastic elongation of the stem 502, the traction ceases.

The stem 502 therefore tends to resume at least partially its original dimensions and moves the base 505 of one of the frustum-shaped members 504 into abutment against the second member 560.

The two members to be joined are consequently locked between the wider head 503 and the frustum-shaped member 504 that is located, with respect to the head, at a distance that is substantially equal to the thickness of the first member 550 and of the second member 560.

However, the elasticity of the stem 502 still allows a minimal freedom of motion to the members to be joined. This characteristic, in case of accidental stresses, allows safeguarding the integrity of the first member 550 and of the second member 560.

The frustum-shaped member 504 that abuts against the second member 560 might be the one closest to the wider head 503, as shown in FIGS. 23 to 25, or one that lies closer to the extension 506, as shown in FIGS. 26 to 28.

Finally, the excess portion of the fastener 501, constituted only by the extension 506 or also by some frustum-shaped members 504, is removed.

The frustum-shaped members 504 have the prerogative of being safe against injury, and therefore, even if one of them protrudes from the second member 560, this does not compromise the safety of the wearer.

By way of example, the first member 550 might be constituted by a filtering or corrective lens, while the second member 560 might be constituted by the portion of a frame.

In a different possibility of application, the first member 550 is constituted by a filtering lens, while the second member 560 is a corrective lens, or vice versa.

With reference to FIGS. 29 to 36, a fastener according to the invention is globally designated by the reference numeral 601.

The fastener 601 comprises an elastically deformable slender body, which can be inserted within non-threaded through holes 651, 671 and 681, which are provided respectively in lenses 650 or in portions of frames such as for example the members 670 and 680.

The slender body has a monolithic structure, preferably made of polyurethane resin, and is constituted by a substantially cylindrical stem 602 whose diameter corresponds substantially to the diameter of the through holes 651, 671 and 681.

A disk head 603 is provided at a first end of the stem 602 and has a diameter that is greater than, or equal to, the diameter of the stem 602.

Frustum-shaped members 604 are provided at a second end of the stem 602, which lies opposite the preceding one. The frustum-shaped members 604 are arranged in series and are terminated by an extension 606. They are substantially mutually identical and are oriented so that the bases 605 are directed toward the head 603.

The frustum-shaped members 604 are elastically compressible and the diameter of their bases 605 is greater than the diameter of the stem 602.

The stem 602 and the frustum-shaped members 604 tend to resume their original shape and dimensions, when the stresses that deformed them ceases, and therefore the fastener 601 may be inserted into the through holes 651, 671 and 681 and to couple it to the supports in which the holes are provided.

The fastener 601 may be coupled to the second member to be fixed, taking advantage of the action of the head 603 and of a frustum-shaped member 604.

According to the invention, the fastener 601 comprises a receptacle 610 that is formed longitudinally on the slender body and is designed to accommodate a coupling member that has an elongated shape.

The coupling member can be constituted by a pin 661 or 701 or by a screw 690, and the receptacle 610 is constituted by a substantially cylindrical cavity that opens on the head 603 and has such a depth as to affect the stem 602 and optionally also the frustum-shaped members 604.

The pivot 661 or 701 is provided with a plurality of claw-shaped protrusions 662 or 702, which facilitate its penetration within the receptacle 610 and contrast its exit.

In the case of the screw 690, it is instead the thread that facilitates penetration and ensures retention.

The fastener according to the invention can be used as described hereinafter.

As shown in FIGS. 31 and 32, the fastener 601 is first coupled to a first member to be fastened, which is constituted generally by a portion of a spectacles frame 660.

This operation is completed by inserting the pin 661 in the receptacle 610, so that the claw-shaped protrusions 661 grip the internal surface of the latter.

Subsequently, after inserting the extension 606 within the through hole 651 formed in a second member to be fastened, constituted for example by the lens 650, traction is applied to the fastener 601.

The stress produces a deformation that allows the frustum-shaped members 604 to pass through the second member to be fastened and simultaneously allows the pin 661 to enter the through hole 651 together with the stem 602.

When the head 603 abuts against the second member to be fastened and at least one of the frustum-shaped members 604 emerges from the through hole 651, the traction ceases.

If the head 603 has the same diameter as the stem 602, the traction is interrupted when the first member to be fastened directly abuts against the second member to be fastened.

After undergoing an elastic elongation, the stem 602 tends to resume its original dimensions and also moves the base 605 of the frustum-shaped member 604 closer to the second member to be fastened and in abutment thereon.

The fastener 601, previously coupled to the first member to be fastened, is then also coupled to the second member to be fastened by means of the head 603 and a frustum-shaped member 604.

The installation is concluded by removing the excess portion of the fastener 601, which is constituted by the extension 606 alone or also by some frustum-shaped members 604.

As shown in FIGS. 35 and 36, in which the fastener 601 is used substantially as already described, the first member to be fastened is constituted by the portion of a frame 660 and also by a decoration 700 that is provided with a pin 701 equipped with claw-shaped protrusions 702.

In a further implementation, shown in FIGS. 33 and 34, the fastener 601 can be used as the pivot of a hinge that is formed by two members 670 and 680, provided respectively with through holes 671 and 681.

In this case, the extension 606 is in fact inserted in the through holes 671 and 681 and then traction is applied to the fastener 601.

The stress forces the insertion of the frustum-shaped members 604 in the through holes 671 and 681 and induces them to pass through the entire thickness of the hinge.

When the stem 602 is inserted perfectly in the through holes 671 and 681 and the head 603 abuts against a first side of the member 670, the traction is stopped.

The stem 602 then tends to retract elastically and moves the base 605 of a frustum-shaped member 604 into abutment against the second side of the member 670.

Also in this case, the installation is concluded by removing the excess portion of the fastener 601.

If the articulation between the two members 670 and 680 is excessively loose, a screw 690 can be inserted in the receptacle 610 so as to expand the stem 602 and compress it slightly within the through holes 671 and 681.

If instead the articulation is found to be excessively movable, it is possible to insert a substantially rigid pin in the receptacle 610 so as to give the stem 602 greater non-deformability.

In practice it has been found that the fastener, particularly for lenses, according to the invention, fully achieves the intended aim, since it allows simplifying the mounting of lenses on frames that use coupling members with an elongated shape for fixing.

The fastener according to the invention can be installed without using particular tools and without providing any threads.

Also, the fastener according to the invention, after installation, is concealed from sight.

In practice it has been found that the fastener according to the invention, fully achieves the intended aim, since it allows performing precise, safe and fast assemblies, minimising the probability of lens breakage.

Also, the fastener according to the invention can be easily replaced in case of breakage and is substantially invisible after assembly.

In practice, the materials used, so long as they are compatible with the specific use, as well as the contingent shapes and dimensions, may be any according to the requirements and the state of the art.

This application claims the priority of Italian Patent Applications No. VI2008A000105, filed on May 9, 2008, No. VI2008A000132, filed on Jun. 4, 2008, and No. VI2008U000048, filed on Dec. 5, 2008, the subject matter of which is incorporated herein by reference.

1. A fastener, particularly for lenses, comprising an elastically deformable elongated body that is suitable to be inserted in through holes formed in one of the members to be joined, said elongated body comprising a substantially cylindrical stem that has a first end that forms a wider head and a second end that forms a plurality of frustum-shaped members that are arranged in series; said frustum-shaped members having bases that are directed towards said wider head; said second end terminates in an extension; a diameter of said wider head and a diameter of said bases being greater than a diameter of said stem.

2. The fastener according to claim 1, wherein said head comprises at least one elastically deformable ring, the central axis of said ring being transverse with respect to the longitudinal axis of said stem.

3. The fastener according to claim 1, wherein said head comprises a second plurality of frustum-shaped members that are arranged in series and end with a second extension, the bases of said second plurality of frustum-shaped members being oriented in the same direction and having a larger diameter than said stem, said second plurality of frustum-shaped members being opposite with respect to said first plurality of frustum-shaped members.

4. The fastener according claim 3, wherein said second plurality of frustum-shaped members is substantially concordant with said first plurality of frustum-shaped members.

5. The fastener according to claim 1, wherein said head comprises a disk member provided with a contoured portion whose profile is substantially complementary to the profile of the transverse cross-section of said stem, a central axis of said disk member being substantially parallel to a longitudinal axis of said stem.

6. The fastener according to claim 1, wherein said head comprises an elastically deformable cap that has a substantially cylindrical shape, a longitudinal axis of said cap being transverse with respect to a longitudinal axis of said stem.

7. The fastener according to claim 1, wherein said stem comprises a substantially rigid jacket, said jacket having a diameter substantially corresponding to a diameter of said through holes.

8. The fastener according to claim 1, wherein said stem has a diameter that substantially corresponds to a diameter of said through holes.

9. The fastener according to claim 1, wherein said through holes are not threaded.

10. The fastener according to o claim 1, wherein the distance between said head and at least one of the bases of said first plurality of frustum-shaped members is slightly shorter than the thickness of said members to be connected.

11. The fastener according to claim 1, wherein said elongated body is formed monolithically by injection-moulding polyurethane resins.

12. The fastener according to claim 1, wherein said elongated body is made of substantially transparent material.

13. (canceled)

14. The fastener according to claim 1, wherein said wider head and at least one of said bases are spaced from one another by a distance that corresponds substantially to a sum of thicknesses of said members to be joined.

15. The fastener according to claim 1, wherein said wider head has an exposed face that allows the provision of indications, figures, logos and any sign or ornament.

16. The fastener according claim 1, further comprising a receptacle that is formed longitudinally on said elongated body, said receptacle being suitable to accommodate a coupling member with an elongated shape that extends from a first member to be fixed.

17. The fastener according to claim 16, wherein said receptacle comprises a substantially cylindrical cavity that opens onto said head, said substantially cylindrical cavity having a shape that is substantially complementary to the shape of said coupling member and such a depth as to affect said stem and at least partly said frustum-shaped members.

18. The fastener according to claim 16, wherein said stem has a diameter that substantially corresponds to a diameter of at least one through hole that is not threaded and is formed in a second member to be fastened.

19. The fastener according to claim 16, wherein said head has a diameter that is greater than, or equal to, a diameter of said stem.
